(19) United States
(12) Patent Application Publication
(10) Pub. No.: US 2009/0080969 A1
(43) Pub. Date: Mar. 26, 2009

(54) Detachable connector assembly

(75) Inventor: Wen-Te Ho, Taichung (TW)

Correspondence Address: BACON & THOMAS, PLLC, 625 SLATERS LANE, FOURTH FLOOR, ALEXANDRIA, VA, 22314-1176, US

(73) Assignee: GRACE CHANCE ENTERPRISE CO., LTD, SHENZHEN CITY (CN)

(21) Appl. No.: 12/010,913

(22) Filed: Jan. 31, 2008

(30) Foreign Application Priority Data
Sep. 21, 2007 (CN) 200720171941.7

(51) Int. Cl. F16B 7/04

(52) U.S. Cl. 403/350; 403/81

(57) ABSTRACT

A detachable connector assembly has a bracket, an active dowel and a lever. The bracket has a clamping recess. The active dowel has a shaft and a shaft cover. The shaft has a head, a central segment and a mounting end. The central segment is formed coaxially on and smaller than the head. The mounting end is formed coaxially on the central segment. The shaft cover is mounted around the central segment and the mounting end. The bracket and the active dowel are mounted inside two perpendicular panels respectively with the head of the active dowel inserted in the clamping recess. A person rotates the lever to drive the bracket around, thereby pulling the head further into bracket, the shaft cover is pressed further into the panel around the mounting end, thereby holding the shaft in the panel and securing the panels and connecting assembly together.

### BACKGROUND OF THE INVENTION

1. Field of Invention

The present invention relates to a connector assembly, and more particularly to a detachable connector assembly that is used to detachably connect two perpendicular panels.

2. Description of the Related Art

Ready-to-assemble (RTA) furniture reduces manufacturing, transport and storage costs are reduced. People use fixing devices such as screws or nails to mount panels perpendicularly to form the RTA furniture. Sometime a person might need to disassemble the RTA furniture to relocate the RTA furniture to the other room or when moving house. Removing each screw and nail to disassemble the RTA furniture is time consuming, may damage the panels and lead to loss of the screws or nails.

Moreover, the initial assembly is also time consuming, tiring and may require additional tools since each nail and screw must be driven into the panel, which may cause damage to the panels and dissuades many people from purchasing RTA furniture.

The present invention provides a detachable connector assembly to obviate or mitigate the shortcomings of the conventional fixing devices.

### SUMMARY OF THE INVENTION

The primary objective of the present invention is to provide a detachable connector assembly that is easily mounted detachably between two panels to securely hold the panels perpendicularly.

The detachable connector assembly comprises a bracket, an active dowel and a lever. The bracket has a clamping recess. The active dowel has a shaft and a shaft cover. The shaft has a head, a central segment and a mounting end. The central segment is formed coaxially on and smaller than the head. The mounting end is formed coaxially on the central segment. The shaft cover is mounted around the central segment and the mounting end. The bracket and the active dowel are mounted inside the perpendicular panels respectively with the head of the active dowel inserted in the clamping recess. A person rotates the lever to drive the bracket around, thereby pulling the head further into bracket, the shaft cover is pressed further into the panel around the mounting end, thereby holding the shaft in the panel and securing the panels and connecting assembly together.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a detachable connector assembly in accordance with the present invention;

FIG. 2 is an exploded perspective view of another embodiment of a detachable connector assembly in accordance with the present invention;

FIG. 3 is an exploded front view in partial section of the detachable connector assembly in FIG. 1;

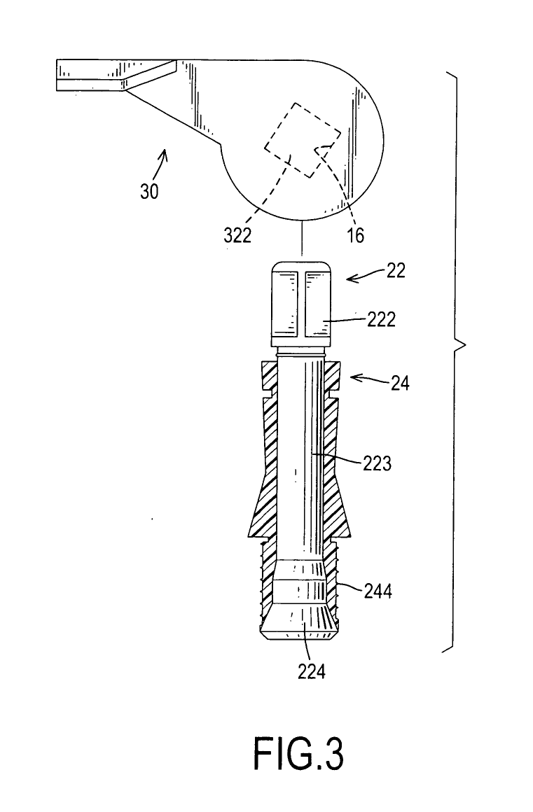

FIG. 4 is an operational perspective view of the detachable connector assembly in FIG. 1, shown partially in phantom lines and mounted in two panels; and

FIG. 5 is operational front view in partial section of the detachable connector assembly in FIG. 1, the connector assembly shown mounted in, connecting and holding two panels perpendicularly.

### DETAILED DESCRIPTION OF THE INVENTION

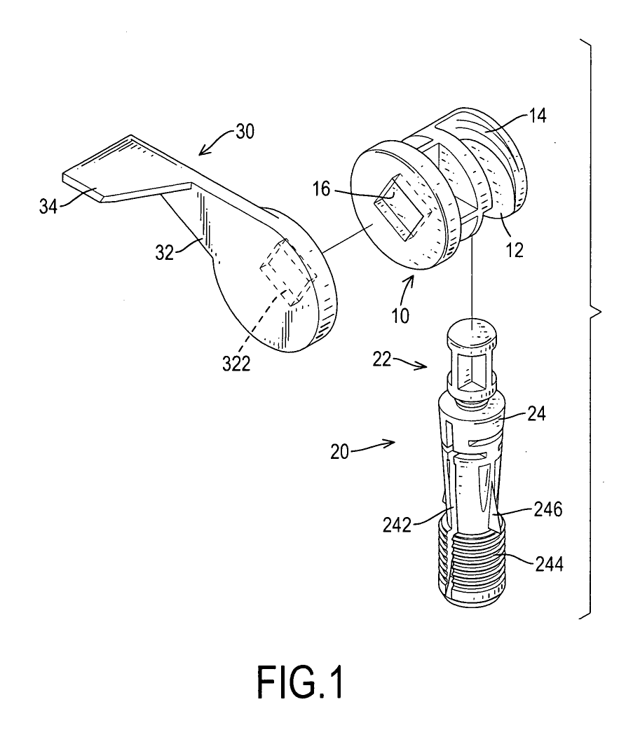

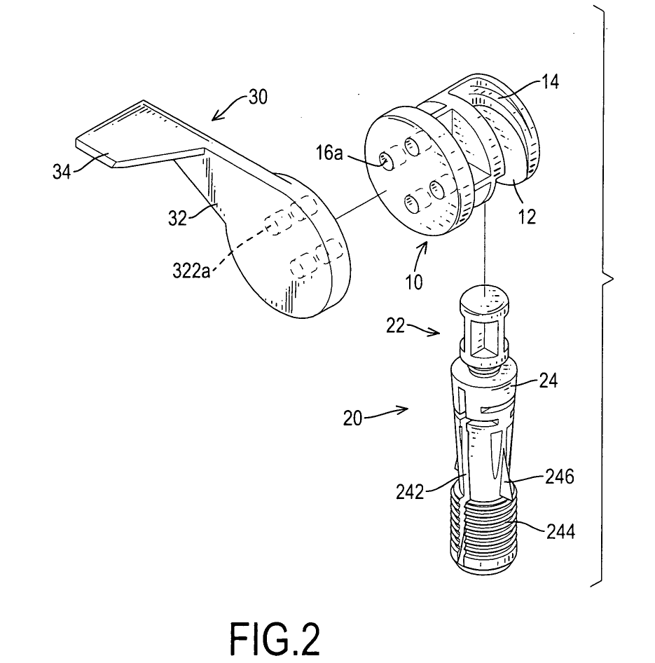

With reference to FIGS. 1, 2, a detachable connector assembly in accordance with the present invention comprises a bracket (10), an active dowel (20) and a lever (30).

The bracket (10) is a cylinder, comprising a lever disc, an insertion disc, an annular surface, a clamping recess (12), at least one clamping tab (14) and at least one keyed recess (16).

The annular surface is formed coaxially on, protrudes from and may be smaller than the lever disc.

The insertion disc is formed coaxially on the annular surface, has a diameter a same size as the annular surface and is parallel to the lever disc.

The clamping recess (12) is transversely formed in the annular surface close to the insertion disc of the bracket (10) and forms two opposite inner surfaces that may be parallel to the insertion disc of the bracket (10). The clamping tabs (14) are oppositely formed on and protrude respectively from the inner surfaces of the clamping recess (12), are curved exponentially from the annular surface and each has an engaging end and a holding end. The engaging end of each clamping tab (14) is formed at the annular surface.

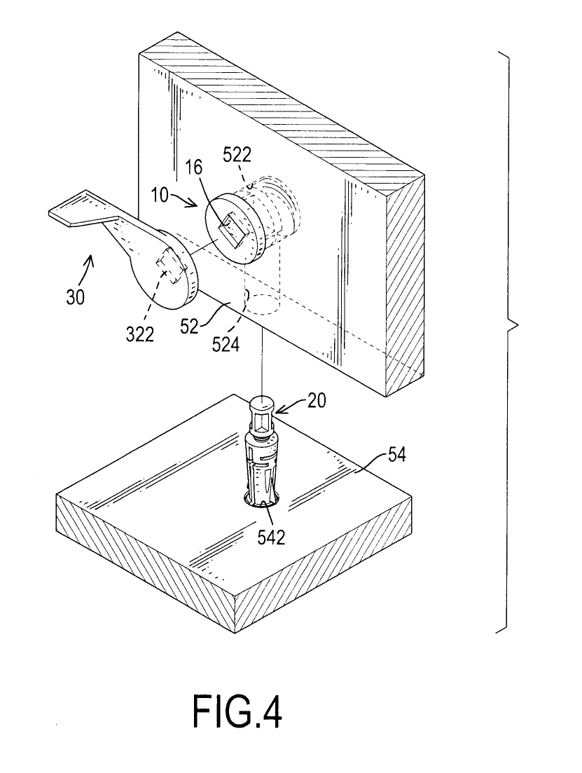

With further reference to FIG. 4, the keyed recess (16) is formed on the lever disc of the bracket (10) and may be a triangular, quadrangular, hexagonal or the like. In a preferred embodiment of the present invention, the keyed recess (16) is quadrangular. In a second embodiment of the present invention, four keyed recesses (16a) being cylinders and being symmetrically formed on the lever disc of the bracket (10).

The active dowel (20) has a shaft (22) and a shaft cover (24). The shaft (22) has a head (222), a central segment (223) and a mounting end (224). The head (222) corresponds to the clamping recess (12), is larger than the shaft and is movably mounted inside the clamping recess (12) and held securely by the clamping tabs (14) in the bracket (10).

The central segment (223) is formed from and protrudes coaxially from the head and is partially inserted slidably inside the clamping recess (12).

The mounting end (224) is formed on and protrudes coaxially from the central segment, is larger than the central segment (223) and is tapered towards the central segment of the shaft (22).

The shaft cover (24) is tubular, corresponds to the shaft (22), is slidably mounted around the shaft (22) and has a proximal end, a distal end, a tubular surface, at least one expansion slot (242), a frictional surface (244) and multiple optional stoppers (246). The distal end of the shaft cover (24) is slidably mounted around the central segment (223). The proximal end of the shaft cover (24) has an opening corresponding to the mounting end (224). The opening of the distal end of the shaft cover (24) may be smaller than the mounting end of the shaft (22) The expansion slots (242) are formed longitudinally through the tubular surface and the distal end of the shaft cover (24).

The frictional surface (244) may be multiple ribs or spots, are formed on and protrude from the tubular surface adjacent to the proximal end of the shaft cover (24).

Each stopper (246) is a triangular tab radially formed on and protruding longitudinally on the tubular surface adjacent to the frictional surface (244) and tapered away from the proximal end.

The lever (30) has a lever body (32) and may comprise a wing (34). The lever body (32) partially corresponds to the keyed recess (16), is detachably mounted on the keyed recess (16) and may have at least one keyed plug (322). The at least one keyed plug (322) corresponds to and being detachably mounted on the keyed recess (16). In the preferred embodiment of the present invention, a keyed plug (322) is a quadrangular. In the second embodiment of the present invention, two keyed plugs (322a) are cylinder formed on and protrude from the lever (30) corresponding to two of the key recesses (16a). The wing (34) is formed on and protrudes perpendicularly from the lever body (32) to aid rotation of the lever (30) when rotating the bracket (10).

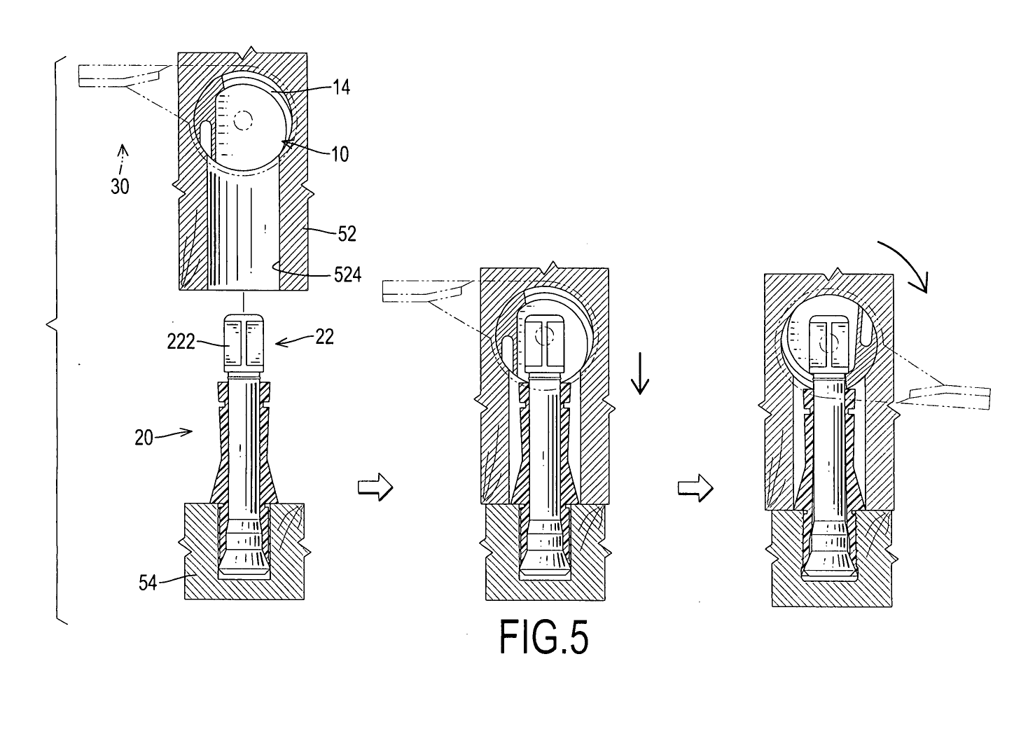

With further reference to FIGS. 4 and 5, the bracket (10) and the active dowel (20) are detachably mounted respectively inside a bracket panel (52) and a dowel panel (54) to mount the panels (52, 54) perpendicularly.

The bracket panel (52) has a side, an edge, bracket hole (522) and a dowel hole (524). The bracket hole (522) is formed in the side of the bracket panel (52). The dowel hole (524) is formed in the edge of the bracket panel (52) and communicates with the bracket hole (522).

The dowel panel (54) has a surface and a dowel hole (542). The dowel hole (542) is formed in the surface of the dowel panel (54) and has an inner surface.

During assembly, the bracket (10) is detachably mounted inside the bracket hole (522) of the first panel (52) with the clamping recess (12) aligned with the dowel hole (522). The mounting end (224) of the active dowel (20) is mounted inside the fixing hole (542).

The two panels (52, 54), are positioned adjacent to each other and the active dowel (20) is inserted through the dowel hole (524) so the head (222) is disposed inside the clamping recess (12).

Then, a person can rotates the bracket (10) using the lever (30), thereby driving the head (222) along the clamping tabs (14) and pulling the head (222) further into the clamping recess (12), effectively shortening the shaft cover (24) and causing the shaft cover (24) to be pushed further into the dowel hole (542) and force the frictional surface (244) to abut the inner surface of the dowel hole (542) tightly hold the connection assembly and panels (52, 54) together.

Moreover, the connecting assembly uses holes (522, 524, 542) formed in the panels (52, 54) that are not visible from outside and improve an aesthetic appearance of the panels.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A detachable connector assembly comprising
a bracket being a cylinder and comprising
a lever disc;
an annular surface being formed coaxially on and protruding from the lever disc;
an insertion disc being formed coaxially on the annular surface, being parallel to the lever disc and having a same diameter as the annular surface;
a clamping recess being transversely formed in the annular surface and having two inner surfaces;
at least one clamping tab being formed on and protruding from one of the inner surfaces of the clamping recess, being curved exponentially away from the annular surface and each one of the at least one clamping tab having
an engaging end being formed at the annular surface; and
a holding end; and
at least one keyed recess being formed on the lever disc of the bracket
an active dowel having
a shaft and having
a head corresponding to the clamping recess, being larger than the shaft and movably mounted inside the clamping recess and being held securely by the clamping tab;
a central segment being formed from and protruding coaxially from the head and being partially inserted slidably inside the clamping recess; and
a mounting end being formed on and protruding coaxially from and being larger than the central segment, and being tapered towards the central segment of the shaft; and
a shaft cover being tubular, corresponding to the shaft, being slidably mounted around the shaft and having
a distal end being slidably mounted around the central segment;
a proximal end having an opening corresponding to the mounting end;
a tubular surface;
at least one expansion slot being formed longitudinally through the annular surface and the distal end of the shaft cover; and
a frictional surface being formed on the annular surface of the shaft cover; and
a lever having a lever body comprising at least one keyed plug corresponding to and being detachably mounted on the at least one keyed recess.

2. The detachable connector assembly as claimed in claim 1, wherein the lever further comprises a wing being formed on and protruding perpendicularly from the lever body.

3. The detachable connector assembly as claimed in claim 1, wherein the frictional surface has multiple ribs being formed on and protruding from the tubular surface adjacent to the proximal end of the shaft cover.

4. The detachable connector assembly as claimed in claim 1, wherein the shaft cover has multiple stoppers being triangular tabs radially formed on and protruding perpendicularly from the tubular surface adjacent to the frictional surface and tapered away from the proximal end.

5. The detachable connector assembly as claimed in claim 1, wherein the bracket has two clamping tabs being formed oppositely on and protruding respectively from the inner surfaces of the clamping recess.

6. The detachable connector assembly as claimed in claim 1, wherein the inner surfaces of the clamping recess are parallel to the insertion disc of the bracket.

7. The detachable connector assembly as claimed in claim 2, wherein
the lever further comprises a wing being formed on and protruding perpendicularly from the lever body.

8. The detachable connector assembly as claimed in claim 2, wherein the shaft cover has multiple stoppers being triangular tabs radially formed on and protruding perpendicularly from the tubular surface adjacent to the frictional surface and tapered away from the proximal end.

9. The detachable connector assembly as claimed in claim 2, wherein the bracket has two clamping tabs being formed oppositely on and protruding respectively from the inner surfaces of the clamping recess.

10. The detachable connector assembly as claimed in claim 8, wherein the bracket has two clamping tabs being formed oppositely on protruding respectively from the inner surfaces of the clamping recess.

11. The detachable connector assembly as claimed in claim 10, wherein
the lever further comprises a wing being formed on and protruding perpendicularly from the lever body.

12. The detachable connector assembly as claimed in claim 10, wherein each one of the at least one keyed plug is quadrangular.

13. The detachable connector assembly as claimed in claim 10, wherein
four keyed recesses being symmetrically formed on the lever disc of the bracket; and
two keyed plugs partially corresponding to the keyed recesses and being detachably mounted on two of the keyed recesses.
